(19) United States
(12) Patent Application Publication
(10) Pub. No.: US 2003/0208588 A1
(43) Pub. Date: Nov. 6, 2003

(54) Systems and methods for directing content without compromising privacy

(76) Inventor: Michael M. Segal, Brookline, MA (US)

Correspondence Address: ROPES & GRAY LLP, ONE INTERNATIONAL PLACE, BOSTON, MA, 02110-2624, US

(21) Appl. No.: 09/770,808

(22) Filed: Jan. 26, 2001

Related U.S. Application Data
(60) Provisional application No. 60/178,172, filed on Jan. 26, 2000.

(51) Int. Cl. G06F 15/16; G06F 15/173

(52) U.S. Cl. 709/224; 709/203

(57) ABSTRACT

The present invention provides systems and methods for gathering information about a person, maintaining this information within a protective zone that is isolated from third parties, maintaining the identities of available third party data content, producing a set of identified targeted third party data content based upon the gathered information and the identities of available third party data content, and directing the identified targeted data content to an end user's computer. In this way, detailed private information may be collected and processed within a protective zone to identify targeted data content, such as advertisements, for example, whereby the only information that leaves the protective zone are the requests for the identified targeted data content. These systems and methods can be utilized to obtain targeted third party medically-related data content without compromising one's privacy.

### REFERENCES TO RELATED APPLICATION

This case claims priority to U.S. Application No. 60/178,172, entitled “Systems and Methods for Directing Targeted Advertising” and filed Jan. 26, 2000, the contents of which are herein incorporated by reference.

### FIELD OF THE INVENTION

This invention relates to methods and systems for directing targeted data content to an end user. More particularly, the invention relates to methods and systems for directing targeted data content over a network to an end user without compromising one's privacy.

### BACKGROUND OF THE INVENTION

It is understood that targeted advertising, i.e., targeted data content, is highly valued by marketers, who may pay premiums of two to twenty-fold over generic advertising in recognition of the higher potential for sales that accompanies targeted ads. By tracking and collecting information of a person's characteristics, interests, conditions, inquiries or needs, etc., to create a user profile so that data content which may be of interest to that person can be identified and directed to that person. In this way, data content which may be highly relevant or of interest to a particular user can be directed to that user. Methods currently available for directing targeted data content to a user include the collection of transactional information, collecting information about a person's Web surfing patterns and interests, and collecting private information such as search keywords, to name a few.

Under such existing methods, however, to create user profiles, third parties monitor, collect and aggregate information which many of us would consider to be personal and private—information that we ourselves as users would not intentionally disclose to unknown third parties. Privacy is a paramount concern in our new information age. Recognizing this, many jurisdictions, e.g., many of the European countries, have enacted strict laws prohibiting the collection and dissemination of certain types of data relating to an individual's privacy. Similar types of laws are being considered in the United States, where some regulation of private data collection and dissemination is already in force.

Privacy issues are particularly acute in the medical field. Confidentiality relating to a patient's medical history is a well-established doctrine in both medical ethics and health care law. Violations of patient confidentiality may result in lawsuits directed at the responsible providers or health care organizations. With the increased utilization of network-based medical information databases, the privacy issues surrounding one's medical data has become even more heightened. Recognizing this, legislation on both the state and the federal level is being directed at preventing the loss of confidentiality in handling and transmitting patient information within computer networks and across the Internet.

Like medical information, financial information also represents an area where people are very concerned about maintaining the privacy of their information.

Therefore, a need exists in the art for systems and methods that will permit directing targeted data content over a network to end users without disclosing or otherwise compromising confidential information. In particular, there exists a need in the art for systems and methods that will permit directing targeted data content over a network to end users without disclosing or otherwise compromising private and confidential medical information. Additionally, there exists a need in the art for systems and methods that will permit directing targeted data content over a network to an end user without disclosing or otherwise compromising one's private financial information.

Moreover, there exists a need for a technological solution according to which private information remains within a protective zone that is isolated from third parties, thereby providing the end user with ‘peace of mind’ and ensuring one's compliance with privacy laws.

### SUMMARY OF THE INVENTION

In one embodiment, the present invention provides systems and methods for gathering information about a person, maintaining this information within a protective zone that is isolated from third parties, maintaining the identities of available third party data content, producing a set of identified targeted third party data content based upon the gathered information and the identities of available third party data content, and directing the identified targeted data content to an end user's computer. In this way, detailed private information may be collected and processed within a protective zone to identify targeted data content, such as advertisements for example, whereby the only information that leaves the protective zone are the requests for the identified targeted data content.

In a specific healthcare embodiment, the present invention provides systems and methods for gathering medical information of a patient, maintaining this medical information within a protective zone that is isolated from third parties, maintaining the identities of available third party medically-related data content, producing a set of identified targeted third party data content based upon the gathered medical information and the identities of available third party medically-related data content, and directing the identified targeted data content to a health care provider's computer.

In a specific financial embodiment, the present invention provides systems and methods for gathering financial information of a person, maintaining this financial information within a protective zone that is isolated from third parties, maintaining the identities of available third party financially-related data content, producing a set of identified targeted third party data content based upon the gathered financial information and the identities of available third party financially-related data content, and directing the identified targeted data content to an end user's computer.

In accordance with the present invention, maintaining the person's private (i.e., personal) information within a protective zone can be accomplished in several different ways. In one embodiment, the identified targeted third party data content may be stored, i.e., cached, within a network server which is maintained by a party who is independent of the third parties who are the ultimate sources of the identified targeted third party data content. An end user's computer may thereby forward a request for the identified targeted third party data content to the network server, and the network server may then deliver the requested identified third party targeted data content to the end user's computer without compromising one's private information to any outside sources.

In another embodiment, the end user's computer may forward a request for the identified targeted data content to the network server, the network server then delivers the request to the third party server which contains the identified targeted data content, and then the third party server delivers the requested identified targeted data content to the end user's computer.

In yet another embodiment, the end user's computer may forward a request for the identified targeted data content to the network server, the network server delivers the request to the third party server which contains the identified targeted data content, the third party server may then deliver the requested identified targeted data content to the network server who, in response, forwards the delivered targeted data content to the end user's computer. In this way, the identity, i.e. the network address, of the end user's computer can be masked from the third parties who are the source of the identified targeted data content.

### BRIEF DESCRIPTION OF THE DRAWINGS

The foregoing and other objects and advantages of the invention will be appreciated more fully from the following further description thereof, with reference to the accompanying drawings wherein:

FIG. 1 depicts schematically one embodiment of a system for directing targeted third party data content to an end user's computer;

FIG. 2 depicts schematically one embodiment of a system for directing targeted third party medically-related data content to an end user's computer;

FIG. 3 depicts schematically another embodiment of a system for directing targeted third party data content to an end user's computer;

FIG. 4 depicts schematically another embodiment of a system for directing targeted third party medically-related data content to an end user's computer;

### DESCRIPTION OF THE ILLUSTRATED EMBODIMENTS

To provide an overall understanding of the invention, certain illustrative embodiments will now be described, including systems that directs identified targeted third party medically-related data content, e.g., medically-related advertising, to a health care provider. However, it will be understood by one of ordinary skill in the art that the systems and methods described herein can be adapted and modified for other suitable applications and that such other additions and modifications will not depart from the scope hereof.

The methods and systems of the present invention relate to employing a computer network to permit the direction of identified targeted data content to an end user, i.e., an end user's computer, wherein information gathered about a person is maintained within a protective zone that is isolated from third parties. In one embodiment, these methods and systems can be applied to the targeting of medically-related third party data content to a health care provider. In another embodiment, these methods and systems can be applied to the targeting of medically-related third party data content to a patient. In yet another embodiment, these methods and systems can be applied to the targeting of financially-related third party data content to an end user. It is a realization of the present invention, in all of its embodiments, that it is desirable to target third party data content, e.g., advertisements, to specific end users while maintaining the privacy of the information pertaining to or identifying an end user.

As used herein, the term “person” may refer to an actual human being or a non-human entity such as a corporation, foundation or partnership, etc. Also, the term “third party” as used herein is meant to refer to any person who is not associated with or has a relationship with the end user who is to receive the identified targeted data content. In accordance with this definition, the network server, as presented and discussed below, is not considered to be a third party since the network server is the end user's means for communicating with others in a desired network, and thus a relationship exists between the end user and the network server. Additionally, the term “advertisement” as used herein, is meant to refer at least to any response provided by a third party to an end user whereby the third party provides information, which may include commercial and noncommercial information, to the end user. Furthermore, as used herein, an advertisement may include the traditional type of exhortation related to commercially available goods and services, including information about the goods or services themselves, their availabilities, relative advantages, prices, special pricing, and reasons why a consumer should purchase them, or referrals to other services with advertisements. As used herein, an advertisement may further include non-commercial information directed towards an end user. For example, in response to information gathered indicating a degenerative neurological disease, a request for third party data content may be sent to a support group to provide the end user with information about various support services, or with information about the disease itself.

Or, in response to information indicating a disorder that can be treated by various types of surgery, a request for third party data content, e.g., advertisement material, may be sent to a third party, i.e., its third party server, to provide information about the types of surgical procedures available, or to an insurance company to provide information about the coverage available for particular surgical procedures. Or, in response to a information indicating a disease requiring a specific type of medical or surgical intervention, a request for third party data content may be sent to a third party such as a subspecialty organization to provide information about the risks and benefits of the intervention, or about the procedure itself. In response to the information, a request for third party data content may be sent to a subspecialty organization to provide information indicating why practitioners in its specialty are most appropriate for treating the condition, or to provide a list of board-certified subspecialty members who are available in the end user's geographic area. In some cases the requests for third party data content may be sent directly to an advertiser's, i.e., a third party's, network address (by utilizing its Internet Universal Resource Locator (URL) for example) via a network server, while in other cases the requests may be further processed by the network server prior to being delivered to the advertiser. For example, the network server may add information identifying local practitioners or to add customizing information relating to a managed-care health company to a request prior to it be delivered to an identified third party. These examples are provided as illustrations of the breadth of the terms “third party” and “third party data content” as these terms are employed herein. Other examples of third parties and third party data content, as these terms are used herein, may be readily envisioned by ordinary, skilled practitioners of the relevant arts.

The systems and methods of the present invention relate to the elicitation (i.e., request, and delivery in response to such request) of identified targeted third party data content in response to information gathered about a person wherein the information is maintained in a protective zone that is isolated from third parties. In a preferred embodiment, these systems and methods are applied to medical information relating to a patient wherein the information is entered into an end user's computer. In another embodiment, these systems and methods can be applied to financial information relating to a particular person. For example, confidential information, i.e., data, related to a home mortgage application may be gathered and correlated with available third party data content to elicit advertisements from companies whose products and services pertain to new home ownership, such as insurance, furniture and home improvement service providers, for example. Confidential data related to a home mortgage application may also be processed to elicit advertising from financial service companies or other entities involved in financial planning or asset allocation. Additionally, the loan officer who enters the personal financial data from the mortgage application into a computer may also be targeted for advertisements relevant to their industry.

Moreover, it is understood that the present invention may be applied to any transaction wherein private information about a person is maintained in a protective zone isolated from third parties, the gathered information is correlated with available third party data content producing a set of identified targeted data content, and then requesting and receiving the identified targeted data content. While the illustrations provided herein relate to the use of these systems and methods in the medical field, other examples will be readily evident to ordinarily skilled practitioners in relevant arts. For example, lawyers specializing in title searches or residential real estate may find these methods and systems to be useful. As another example, these systems and methods may be employed by a tax preparer who elicits third party data content related to updates in the tax laws. The tax preparer may also elicit advertising directed to the client regarding banks or other financial institutions which are available to loan the client the short-term cash needed to pay his taxes. The tax preparer may also elicit advertisements from attorneys or other tax-related specialists, when the gathered information relating to the client's needs yields appropriate targeted third party data content.

In one embodiment, these systems and methods provide “business-to-professional” health care information to physicians over the Internet. The services contemplated by the present invention may be directed to physicians or other health care providers who are gathering confidential information about a person on a computer which is connected to a network, e.g., the Internet. For example, the systems and methods of the present invention may operate in conjunction with a medical diagnostic tool that delivers many of the functions of a medical consultation, allowing a health care provider to interact with a patient, to compile a list of medical findings related to the patient and to interrogate a database in real time to obtain guidance in formulating more educated questions for gathering data from the patient, and in ordering laboratory tests more efficiently. Available diagnostic tools that provide this real-time consultation function are analogous to the traditional pattern of obtaining diagnostic assistance through phone conversations with colleagues in the patient's presence or at a separate time.

At the same time as an end user, e.g., a physician, is interfacing with a medical diagnostic tool to obtain real-time diagnostic guidance, the end user may be compiling a record of medical information that relate to a particular patient. It is understood that this medical information needs to be kept confidential. The systems and methods of the present invention permit a distillation of the patient's medical data, on the end user's computer, into a form so that it can be correlated with available third party medically-related data content to elicit identified targeted advertisements from the third parties without compromising the patient's confidential medical data.

In one embodiment, the systems and methods of the present invention related to targeted third party data content may be used in conjunction with medical diagnostic tools as described above that provides diagnostic decision support using real time information about patients to assist in making diagnoses. In such an embodiment, these diagnostic services may be supported by revenues generated by the advertising streams generated from the pool of the available third party medically-related data content. It is understood that a great deal of advertising is directed to health care providers and to consumers of health care resources. Products and systems produced according to the present invention may allow producers of health-related products, services, information and other content to direct their most highly targeted advertisements to the most appropriate health care providers and patients, achieving the much valued goal of reaching the physician at the “point of prescription” or the patient at the “point of purchase,” while still maintaining the confidentiality of the medical information. The systems and methods of the present invention may track the clinical issues being considered by a physician since these can be stored in the physician's computer. A digest of these clinical issues may be formulated on the physician's computer and reduced to a request, based upon the gathered information, which can be directed to an advertiser (i.e., forward a request for the identified targeted data content to the appropriate third party) to deliver the identified targeted data content. Thus, third party data content may be requested from the advertiser, i.e., third parties, without compromising the gathered personal information. In this way, one patient “information gathering” session may result in a multitude of identified targeted data content being delivered to the patient or the clinician in the time span of a couple of minutes. Accordingly, the systems and methods of the present invention allow advertisers to reach clinicians, e.g., physician, or their patients with direct, one-on-one advertisements that are very relevant to the patient's particular medical situation.

The many features and advantages of the present invention will be understood in more detail by reference to the Figures, which are described in more detail below.

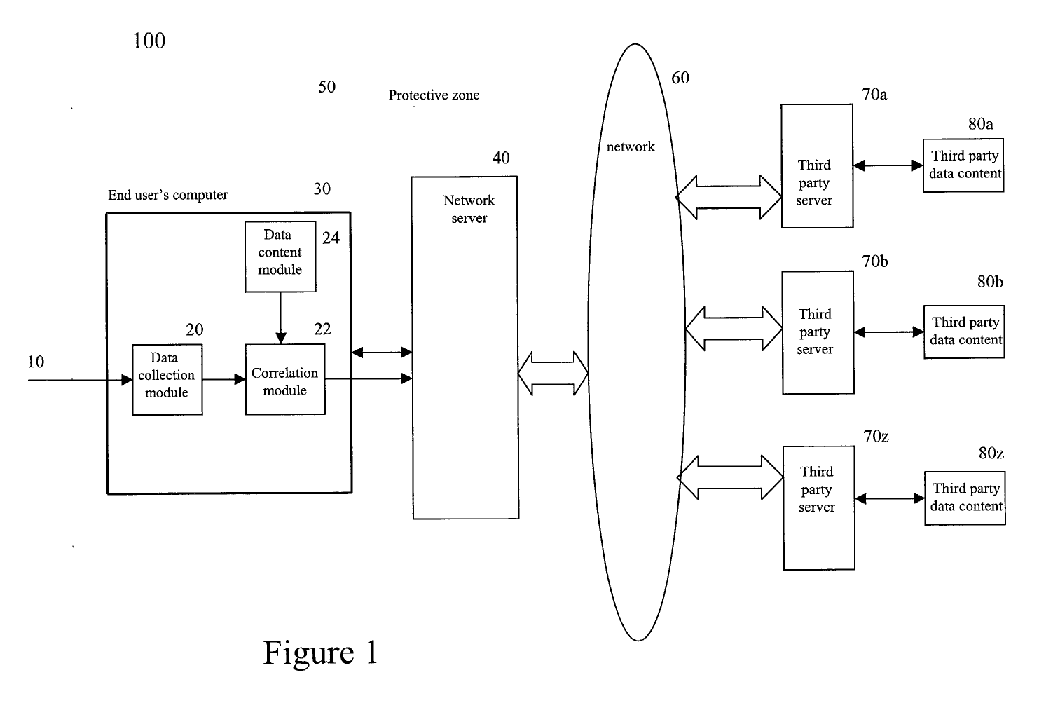

Using FIG. 1 as an illustration, as an initial matter an operator of the system (i.e., the one who implements the systems and methods of the present invention) will assemble information about third party data content which shall constitute the available third party data content 80. In other words, the operator shall research, investigate, solicit, or otherwise assemble, data content that is available from third parties to determine which third party data content will be the available for targeting to potential end user's in accordance with the present invention. Once the operator has decided which third party data content shall be subject to the targeting i.e., the available third party data content 80, the operator may then compile a database of identities corresponding to the available third party data content 80 which can be stored within the data content module 24. The identity of an available third party data content 80a, for example, can be represented by parameters corresponding to the third party data content 80a. The parameters may reflect the third party data content 80a's network location, e.g., its network address and its geographically location, and its content, for example. The identity of the third party data content 80a, for example, may have the parameters of its URL Internet Protocol address, its physical location and a list of descriptors, such as “heart disease,” “family practitioner,” etc., where the descriptors are indicative of the data content held at the location 80a.

As shown, FIG. 1 depicts one embodiment of a system 100 for directing targeted third party data content to an end user's computer 30 located within a network 60 (i.e., the end user's computer 30 has access to and can communicate with the network 60) in accordance with the present invention. FIG. 1 illustrates an embodiment having a data collection module 20 for gathering information about a person, a data content module 24 for maintaining the identities of available third party data content 80, and a correlation module 22 for correlating the gathered information 10 to the available third party data content 80 to produce a set of identified targeted data content corresponding to the gathered information 10 wherein the gathered information 10 is maintained within a protective zone 50 that is isolated from all third parties. In all embodiments of the present invention, the protective zone 50 shall shield the end user's computer 30 and the network to prevent any third parties from accessing the gathered information 10. This protective zone 50 can be maintained by utilizing any of the number of firewall technologies that are presently known in the art.

In the system 100 of FIG. 1, the data collection module 20, data content module 24 and the correlation module 22 reside within the end user's computer 30. Initially, the end user inputs the information 10 into the data collection module 20 via the end user's computer 30. This can be accomplished by having the end user respond to a string of queries which the data collection module 20, via the end user's computer 30, prompts the end user to answer. Once the gathered information 10 is entered into the data collection module 20, the data collection module 20 may then compile the gathered information 10 to generate a profile which is representative of the gathered information 10. Once the gathered information 10 has been assembled, and a profile has been generated as the case may be, the correlation module 22 may then correlate the gathered information 10 to the identities of the available third party data content contained within the data content module 24 to produce a set of identified targeted data content corresponding to the gathered information 10. The set of identified targeted data content corresponding to the gathered information 10 thus represents those of the available third party data content 80 which “matched,” i.e. correlated, the gathered information 10.

Once the set of identified targeted data content has been produced, the correlation module 22, via the end user's computer 30, communicates with the network server 40 so that the network server 40 can direct the identified targeted data content to the end user's computer 30. This can be accomplished in several different ways, all in accordance with the present invention. In one embodiment, the end user's computer 30 may forward the request for the identified targeted data content to the network server 40, and the network server 40 may then deliver the requested identified targeted data content, which may have been previously gathered and stored on the network server 40, i.e., cached, to the end user's computer 30 in response to the request. In another embodiment of the present invention, the end user's computer 30 may forwards the request for the identified targeted data content to the network server 40 wherein the network server 40 then delivers, via the network 60, the request to the appropriate third party server 70 which contains the identified targeted data content. The third party server 70 may then deliver the requested identified targeted data content the end user's computer 30 via the network 60 and the network server 40 in response to this request.

In yet another embodiment of the present invention, the end user's computer 30 may forward the request for the identified targeted data content to the network server 40 which may then deliver the request, via the network 60, to the third party server 70 which contains the identified targeted data content wherein the third party server 70 may then deliver, via the network 60, the requested identified targeted data content to the network server 40. The network server 40 may then deliver the identified targeted data content to the end user's computer 30. In this embodiment, the network server 40 can serve as a proxy for the end user's computer 30 thereby providing an additional privacy feature by hiding the end user's computer 30's network address from the third parties who delivered the identified targeted data content—since they are only are aware that the requested identified targeted data content is to be delivered to the network server 40. Persons skilled in the relevant art will appreciate that these proxy deliveries can be accomplished in accordance with existing technologies, which are beyond the scope of the present invention.

For the depicted system 100, the end user's computer 30 can be any suitable computer system such as a PC workstation, a handheld computing device, a wireless communication device, or any other such device, equipped with a network client capable of accessing a network server 40 and interacting with the network server 40 to exchange information with the network server 40. In one embodiment, the network client is a web client, such as a web browser that can include the Netscape web browser, the Microsoft Internet Explorer web browser, the Lynx web browser, or a proprietary web browser, or web client that allows the user to exchange data with a web server, and ftp server, a gopher server, or some other type of network server. Optionally, the end user's computer 30 (i.e., the client) and the network server 40 rely on an unsecured communication path, such as the Internet, for accessing services on the remote server. To add security to such a communication path, the end user's computer 30 and the network server 40 can employ a security system, such as any of the conventional security systems that have been developed to provide to the end user a secured channel for transmitting data over the Internet. One such system is the Netscape secured socket layer (SSL) security mechanism that provides to a remote user a trusted path between a conventional web browser program and a web server. Therefore, optionally and preferably, the end user's computer 30 and the network server 40 have built-in 128 bit or 40 bit SSL capability and can establish an SSL communication channel between the end user's computer 30 and the network server 40. Other security systems can be employed, such as those described in Bruce Schneir, Applied Cryptography (Addison-Wesley 1996). Alternatively, the systems may employ, at least in part, secure communication paths for transferring information between the network server 40 and the end user's computer 30. For purpose of illustration however, the systems described herein, including the system 100 depicted in FIG. 1 will be understood to employ a public channel, such as an Internet connection through an ISP or any suitable connection, to connect the end user's computer 30 and the network server 40. In certain embodiments of these systems and methods, the systems are provided with proprietary software adapted for the collection and processing of confidential information that is input into the system by the user. This software can be in the computer language Java that allows running of software downloaded from the network server 40 entirely on the en user's computer 30. The systems may optionally be further provided with proprietary databases to allow correlations to be made on the end user's side between the gathered (confidential) information 10 and other relevant data.

The end user's computer 30, such as the one depicted in FIG. 1, are capable of downloading and responding to computer files served by the network server 40 or from other similar servers at advertisers, e.g., the third party servers 70. In particular, the end user's computer 30 can contain a browser program that is capable of forming one or more connections to an HTTP server process for transferring pages from the HTTP server process to the end user's computer 30. Such a browser process can be the Netscape Navigator browser process, the Microsoft Internet Explorer browser process, or any other conventional or proprietary browser process capable of downloading pages generated by the network server 40 or other similar servers at advertisers.

The network server 40 may be supported by a commercially available server platform such as a Sun Sparc™ system running a version of the Unix operating system and running a server capable of connecting with, or exchanging data with, one of the end users' computers 30. In the embodiment of FIG. 1, the network server 40 includes a web server (not shown), such as the Apache web server or any suitable web server. The web server component of the network server 40 acts to listen for requests from subscriber systems, i.e., end users' computers 30, and in response to such a request, resolves the request to identify a filename, script, dynamically generated data that can be associated with that request and to return the identified data to the requesting subscriber system. The operation of the web server component of the network server 40 can be understood more fully from Laurie et al., Apache The Definitive Guide, O'Reilly Press (1997). The network server 40 may also include components that extend its operation to accomplish the integrated financial transactions described herein, and the architecture of the network server 40 may vary according to the application. For example, the web server may have built in extensions, typically referred to as modules, to allow the network server 40 to perform operations related to the delivery of information, including medical information, from third parties to the end user's computer 30, or the web server may have access to a directory of executable files, each of which files may be downloaded by the end user to perform operations or parts of operations related to the delivery of information from third parties. Executable files downloaded to the end user's computer 30 may reside thereupon and be used within a specific subscriber system for the organization and management of confidential information including medical information.

The network server 40 may couple to a database (not shown) that stores information related to a end user's, i.e. subscriber's, account. In one embodiment, the database includes passwords of users, their usual location, and level of permission of the user in sending suggested additions to the database.

The network server 40 may also contain a second database (not shown) containing a patient diagnostic tool 26 (as discussed in detail below) that can be downloaded to the end user's computer 30. This patient diagnostic tool 26 may include information such as details about diseases and findings that are used by the software to make inferences, as well as information about advertisements that are triggered by certain diseases or laboratory tests. These patient diagnostic database storage formats are well-known to practitioners in the art and many are commercially available. In one embodiment, this second database can be downloaded in a compressed CAB or JAR archive file together with the Java program that uses the database within a Web browser. In another embodiment, a CD-ROM may be provided to the subscribers on a periodic basis bearing medical information that may be made available in response to the system's production of a particular patient profile, i.e., the gathered information 10.

The second database may comprise any suitable database system, including a proprietary database format used by a Java program, or a commercially available format such as Microsoft Access database, and can be a local or distributed database system. The design and development of database systems suitable for use with the systems and methods in accordance with this invention, follow from principles known in the art, including those described in McGovern et al., A Guide To Sybase and SQL Server, Addison-Wesley (1993).

Additionally, while FIG. 1 only illustrates a system 100 with a single end user's computer 30 identified to be in communication with the network server 40 and the network 60, etc., it should be evident to those skilled in the relevant art that such a system can easily accommodate a plurality of end users and their computers 30. Also, it should be evident to one skilled in the art that the software and database functions of the end user's computer 30, with its data collection module 20, data content module 24, and correlation module 22, and the network server 40 can be operated by utilizing a programming language such as Java, which may allows these modules to run within a Web browser operating within the end user's computer 30. Moreover, the elements of the system 100 can include commercially available or proprietary systems that have been arranged and modified to act as a system according to the invention, which may allow an end user to compile a profile abstracted from the gathered information 10, and to elicit advertisements or data content from third parties without revealing this confidential gathered information 10. The system 100 of FIG. 1 may employ the Internet, i.e., network 60, to allow an end user, i.e., an end user's computer 30, to access a network server 40 to log into an account maintained by that network server 40, and to employ the services provided to that account to obtain the targeted third party data content, for example a patient diagnostic tool 26 as discussed in greater detail below.

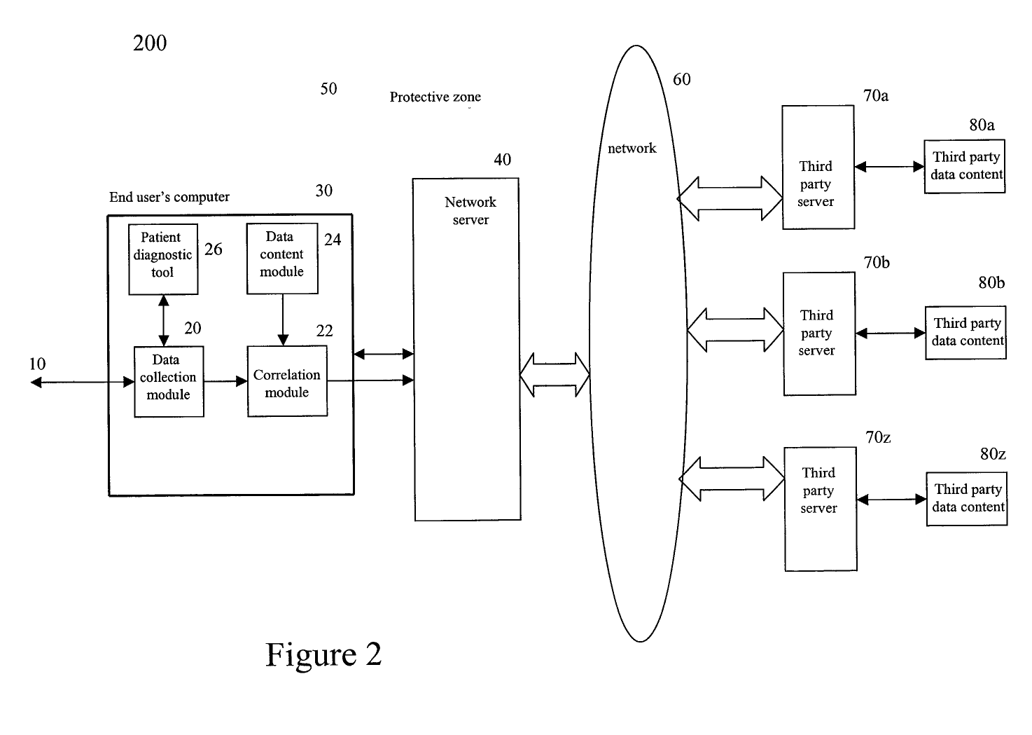

Turning now to FIG. 2. FIG. 2 depicts a particular embodiment of a system 200 for directing targeted medically-related third party data content to an end user's computer 30 located within a network 60 in accordance with the present invention, wherein a patient diagnostic tool 26 interfaces with the data collection module 20 to assist in gathering the information 10. In the embodiments encompassed by FIG. 2, the patient diagnostic tool 26 has been co-located within the end user's computer 30. As previously discussed, a patient diagnostic tool 26 can be utilized in conjunction with the data collection module 20 to provide a real-time feed-back response system that can assist in tailoring some of the queries, which the data collection module 20 prompts the end user to answer, depending upon some of the information, i.e., an answer to a query, provided by the end user. For example, once the end user answers a query prompted by the data collection module 20, the data collection module may then interface with the patient diagnostic tool 26 to determine the next query that will be prompted for the end user to answer, and so on. Once the information has been gathered in this way, the embodiments encompassed by FIG. 2 may operate in the same way as the embodiments of FIG. 1, as discussed above.

In one embodiment of the patient diagnostic tool 26, the knowledge about the diseases and findings deemed relevant may provide guidance to the end user in obtaining more private information 10 from the patient. For example, avenues for further questioning may be suggested, or types of physical findings to be elicited, or diagnostic tests to be undertaken. In response to these suggestions, further private information 10 is gathered and processed as described above. At each point in use of the patient diagnostic tool 26, the matching and assignment portions of the tool, i.e., software product, choose appropriate advertisers triggered by the patient profile and the knowledge about the diseases and findings deemed relevant by either the user or the software. In one embodiment the patient diagnostic tool 26 determines that the most useful action to take next is to order a particular laboratory test, and the software chooses the particular advertiser banner image file associated with that test, sends a request for that file to a third party server 70, and the file is downloaded in accordance with the present invention and displayed within the end user's computer 30. In one embodiment this advertising display includes clickable links that open new browser windows with Web pages displaying further information, with the new browser window opened by using a method such as the show Document method in the browser-oriented programming language Java. In one embodiment this advertising display includes a button that the end user can press to have an e-mail message sent to the end user, for example by using the URL Connection methods of Java to send a message to a third party server 70 to activate a cgi program to send an e-mail message to the end user's computer 30 with further information. As part of this embodiment the patient diagnostic tool 26 determines at some points that a particular disease is most likely and directs the end user, e.g., a physician or a patient, to advertising materials related to that disease such as individuals or organizations involved in treating that disease. At every stage in using the patient diagnostic tool 26 such information about the private patient information and the conclusions of the software about likely diseases and useful findings such as laboratory tests are used to provide a variety of types of advertising material, i.e., identified targeted data content, to the end user, in one embodiment showing the end user tens of advertisements throughout the process of assembling and analyzing the patient profile, i.e., the gathered information 10. In many of these cases the only information leaving the end user's computer 30 is requests for certain advertisements, which preserves the private information of the patient within the end user's computer 30. In the case in which the end user requests information to be sent by e-mail, a large degree of privacy is maintained as well, with the only records leaving the end user's computer 30 being requests by a particular end user to have information e-mailed to the end user. In one embodiment the private information is of a therapeutic nature, and the knowledge about the patient is linked to potential advertisements that are determined according to the condition of the patient as deduced by the patient diagnostic tool 26. In another embodiment the process of gathering information 10 relates to any other type of private information that is analyzed in this way on the end user's computer 30 and used to generate advertising without revealing the underlying private information.

To further illustrate the features and advantages of the present invention, the following example is provided:

### EXAMPLE ONE

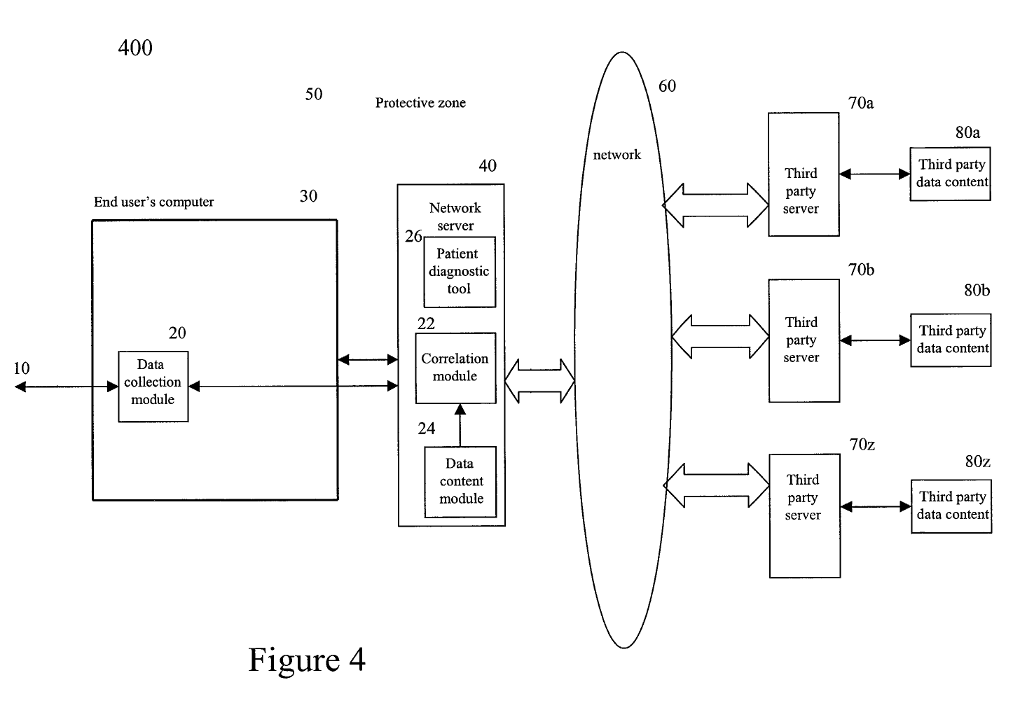

A health care provider enters into the end user's computer 30 confidential medical information about the signs, symptoms and test results of a patient. This confidential medical information, accompanied by demographic information about the patient is stored on the end user's computer 30. The gathered information 10 is processed by a program resident in the end user's computer 30 (as shown in FIG. 2), downloaded in real time from a network server 40, or maintained with the network server 40 (as shown in FIG. 4 below), so that correlations are made between the patient information and those diagnoses that correspond to the gathered information 10. The patient diagnostic tool 26 may derive data from a database in order to correlate the symptoms to a field of possible diagnoses. The program may further query a database that contains medical information that is useful in making a diagnosis or formulating a diagnostic or therapeutic plan. Information from a database that is directed to the patient may also made be available.

As described in this example, a patient diagnostic tool 26 useful for these systems and methods may relate to four distinct types of medical information. First, the patient diagnostic tool 26 may request information about which diseases the health care provider is actively considering to explain the patient's signs and symptoms. Second, the patient diagnostic tool 26 may request information about specific objective or subjective findings in response to the end user's query or in response to the end user's clicking on them or entering them into the patient's medical record. Third, the patient diagnostic tool 26 may provide information about those diagnoses determined by the patient diagnostic tool 26 to relate most closely to the patient's signs, symptoms or lab studies. Fourth, the patient diagnostic tool 26 may provide information about those findings that are deemed most pertinent by the patient diagnostic tool 26.

The four types of medical information available through these systems and methods produce a detailed picture of the health care provider's real time thought processes: what data is deemed relevant and what diagnoses are being considering. Further, the patient diagnostic tool 26 offers suggestions about the diagnoses that the provider should be entertaining and about the findings that that should be considering most important.

These patient diagnostic tool 26 systems and methods are capable of interfacing with third parties who wish to deliver information related to the individual provider's or patient's specific situation. Advertisements targeted to this identified provider and/or patient that are based on the detailed and immediate information included in the present invention are understood to be of great value to the advertiser. However, such private information is not revealed to the advertiser, and in some embodiments is not sent at all from the end user's computer 30, preserving the privacy of the information in the most secure way without abandoning the crucial need to target advertising appropriately. In certain embodiments, the end user and the patient may be the same person, with the patient entering confidential information about himself and generating a profile that preserves his anonymity while eliciting third-party-produced content directed at his medical situation.

The approach described in this example may be suited for increasing the speed of information dissemination, since all computation is local to the client machine. Furthermore, the present invention may restrict the need for maintaining central databases of private location.

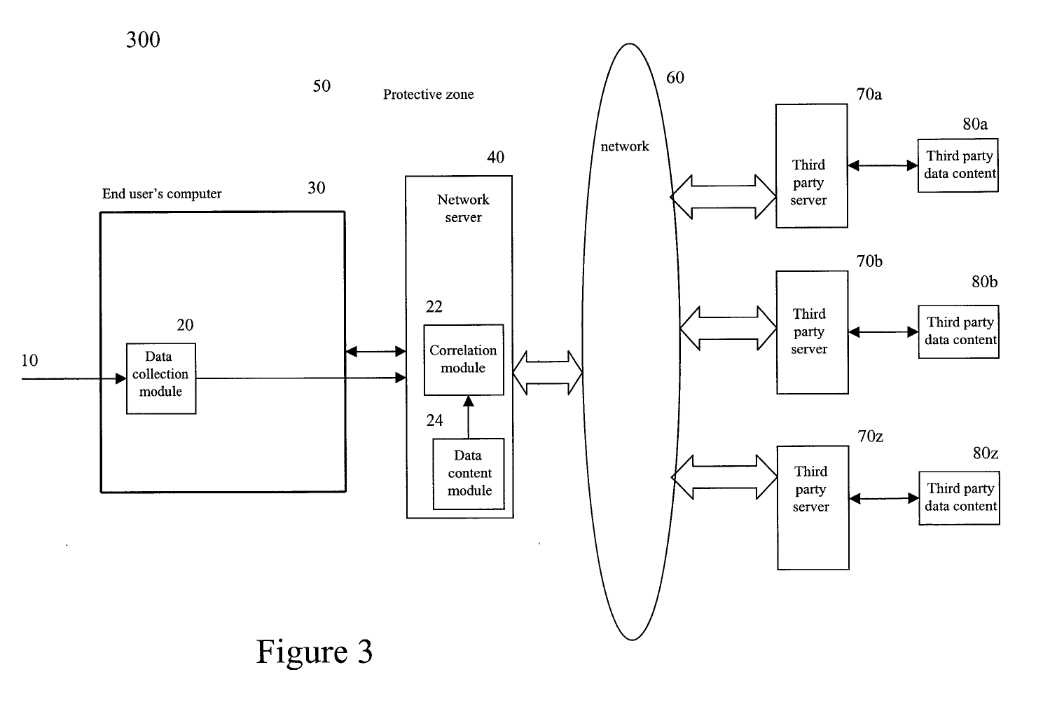

Turning now to FIG. 3. FIG. 3 depicts one embodiment of a system 300 for directing targeted third party data content to an end user's computer 30 located within a network 60 in accordance with the present invention. FIG. 3 illustrates an embodiment having a data collection module 20 for gathering information about a person, a data content module 24 for maintaining the identities of available third party data content 80, and a correlation module 22 for correlating the gathered information 10 to the available third party data content 80 to produce a set of identified targeted data content corresponding to the gathered information 10 wherein the gathered information 10 is maintained within a protective zone 50 that is isolated from all third parties. In all embodiments of the present invention, the protective zone 50 shall shield the end user's computer 30 and the network to prevent any third parties from accessing the gathered information 10.

In the system 300 of FIG. 3, the data collection module 20 resides within the end user's computer 30 and the data content module 24 and the correlation module 22 reside within the network server 40. Initially, the end user inputs the information 10 into the data collection module 20 via the end user's computer 30. Again, this can be accomplished by having the end user respond to a string of queries which the data collection module 20, via the end user's computer 30, prompts the end user to answer. Once the gathered information 10 is entered into the data collection module 20, the data collection module 20 may then compile the gathered information 10 to generate a profile which is representative of the gathered information 10. Once the gathered information 10 has been assembled, and a profile has been generated as the case may be, the data collection module 20 may then deliver, via the end user's computer 30, the gathered information 10 to the correlation module 22 of the network server 40. The correlation module 22 may then correlate the gathered information 10 to the identities of the available third party data content contained within the data content module 24 of the network server 40 to produce a set of identified targeted data content corresponding to the gathered information 10. Again, the set of identified targeted data content corresponding to the gathered information 10 thus represents those of the available third party data content 80 which “matched,” i.e. correlated, the gathered information 10.

Once the set of identified targeted data content has been produced by the data correlation module 24 of the network server 40, the correlation module 22, of the network server 40, communicates with the network server 40 so that the network server 40 can direct the identified targeted data content to the end user's computer 30. This can be accomplished in several different ways, all in accordance with the present invention. In one embodiment, the network server 40 can then deliver the requested identified targeted data content, which may have been previously gathered and stored on the network server 40, i.e., cached, to the end user's computer 30. Persons skilled in the relevant art will appreciate that these cached deliveries can be accomplished in accordance with existing technologies, which are beyond the scope of the present invention. In another embodiment of the present invention, the network server 40 may then forward the request for the identified targeted data content, via the network 60, to the appropriate third party server 70 which contains the identified targeted data content. The third party server 70 may then deliver the requested identified targeted data content to the end user's computer 30, via the network 60 and the network server 40, in response to the request.

In yet another embodiment of the present invention, then network server 40 may forward the request for the identified targeted data content, via the network 60, to the appropriate third party server 70 which contains the identified targeted data content, and the third party server 70 may then deliver the requested identified targeted data content via the network 60 to the network server 40 in response to the request. Then the network server 40 can forward the delivered targeted data content to the end user's computer 30. In this embodiment, the network server 40 can again serve as a proxy for the end user's computer 30 thereby providing an additional privacy feature by hiding the end user's computer 30's network address from the third parties who delivered the identified targeted data content.

Turning now to FIG. 4. FIG. 4 depicts a particular embodiment of a system 400 for directing targeted medically-related third party data content to an end user's computer 30 located within a network 60 in accordance with the present invention, wherein a patient diagnostic tool 26 (as discussed above) interfaces with the data collection module 20 to assist in gathering the information 10. In the embodiments encompassed by FIG. 4, the patient diagnostic tool 26 has been co-located within the network server 40. As previously discussed, a patient diagnostic tool 26 can be utilized in conjunction with the data collection module 20 to provide a real-time feed-back response system that can assist in tailoring some of the queries, which the data collection module 20 prompts the end user to answer, depending upon some of the information, i.e., an answer to a query, provided by the end user. For example, once the end user answers a query prompted by the data collection module 20, the data collection module may then interface with the patient diagnostic tool 26 to determine the next query that will be prompted for the end user to answer, and so on. Once the information has been gathered in this way, the embodiments encompassed by FIG. 4 may operate in the same way as the embodiments of FIG. 3, as discussed above.

In the exemplified embodiment, advertising targeting is carried out without ever sending the confidential information itself out from the end user's computer 30, or storing “cookies” on the end user's computer 30. Since there have been numerous incidents in which third parties have used private information in improper ways, it is understood that a technological solution in which the private information never leaves the end user's computer 30 would be extremely valuable, providing the participants with peace of mind and effecting compliance with existing and future laws.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

I claim:

1. A system for directing targeted third party data content to an end user's computer located within a network, comprising
a data collection module for gathering information about a person wherein said gathered information is maintained within a protective zone isolated from third parties and having an end user's computer and a network server,
a data content module for maintaining the identities of available third party data content wherein said identities contain parameters corresponding to said available third party data content,
a correlation module for correlating said gathered information to said available third party data content to produce a set of identified targeted data content corresponding to said gathered information, and
said network server for directing said identified targeted data content to said end user's computer.

2. The system of claim 1 wherein said gathered information pertains to medical information.

3. The system of claim 2 wherein said end user is a health care provider and said person is a patient.

4. The system of claim 3 further comprising a patient diagnostic tool wherein said patient diagnostic tool interfaces with said data collection module to assist in gathering information about said person.

5. The system of claim 1 wherein said gathered information pertains to financial information.

6. The system of claim 1 wherein said data collection module, said data content module and said correlation module reside within said end user's computer.

7. The system of claim 6 wherein said end user's computer forwards a request for said identified targeted data content to said network server, and said network server delivers said requested identified targeted data content to said end user's computer in response to said request.

8. The system of claim 6 wherein said end user's computer forwards a request for said identified targeted data content to said network server, said network server delivers said request to the third party server which contains said identified targeted data content, and said third party server then delivers said requested identified targeted data content to said end user's computer in response to said request.

9. The system of claim 6 wherein said end user's computer forwards a request for said identified targeted data content to said network server, said network server delivers said request to the third party server which contains said identified targeted data content, said third party server delivers said requested identified targeted data content to said network server in response to said request, and then said network server forwards said delivered targeted data content to said end user's computer.

10. The system of claim 1 wherein said data collection module resides within said end user's computer and wherein said data content module and said correlation module reside within said network server.

11. The system of claim 10 wherein said end user's computer delivers said gathered information to said network server, said network server produces said set of identified targeted data content corresponding to said delivered gathered information by utilizing said data content module and said correlation module, and then said network server delivers said identified targeted data content to said end user's computer.

12. The system of claim 10 wherein said end user's computer delivers said gathered information to said network server, said network server produces said set of identified targeted data content corresponding to said delivered gathered information by utilizing said data content module and said correlation module, said network server forwards a request for said identified targeted data content to the third party server which contains said identified targeted data content, and said third party server then delivers said requested identified targeted data content to said end user's computer in response to said request.

13. The system of claim 10 wherein said end user's computer delivers said gathered information to said network server, said network server produces said set of identified targeted data content corresponding to said delivered gathered information by utilizing said data content module and said correlation module, said network server forwards a request for said identified targeted data content to the third party server which contains said identified targeted data content, said third party server delivers said requested identified targeted data content to said network server in response to said request, and then said network server forwards said delivered targeted data content to said end user's computer.

14. A method for directing targeted third party data content to an end user's computer located within a network, comprising
gathering information about a person wherein said gathered information is maintained within a protective zone isolated from third parties and having an end user's computer and a network server,
maintaining the identities of available third party data content wherein said identities contain parameters corresponding to said available third party data content,
correlating said gathered information to said available third party data content to produce a set of identified targeted data content corresponding to said gathered information, and
directing said identified targeted data content to said end user's computer.

15. The method of claim 14 wherein said gathered information pertains to medical information.

16. The method of claim 15 wherein said end user is a health care provider and said person is a patient.

17. The method of claim 16 further comprising utilizing a patient diagnostic tool to aid in the gathering of said medical information.

18. The method of claim 14 wherein said gathered information pertains to financial information.

19. The method of claim 14 wherein said gathering of information, said maintaining of the identities of available third party data content, and said correlating of said gathered information occur within said end user's computer.

20. The method of claim 19 wherein said end user's computer forwards a request for said identified targeted data content to a network server, and said network server delivers said requested identified targeted data content to said end user's computer in response to said request.

21. The method of claim 19 wherein said end user's computer forwards a request for said identified targeted data content to a network server, said network server delivers said request to the third party server which contains said identified targeted data content, and said third party server then delivers said requested identified targeted data content to said end user's computer in response to said request.

22. The method of claim 19 wherein said end user's computer forwards a request for said identified targeted data content to a network server, said network server delivers said request to the third party server which contains said identified targeted data content, said third party server delivers said requested identified targeted data content to said network server in response to said request, and then said network server forwards said delivered targeted data content to said end user's computer.

23. The method of claim 14 wherein said gathering of information occurs within said end user's computer, and wherein said maintaining of the identities of available third party data content and said correlating of said gathered information occurs within a network server.

24. The method of claim 23 wherein said end user's computer delivers said gathered information to said network server, said network server produces said set of identified targeted data content corresponding to said delivered gathered information, and then said network server delivers said identified targeted data content to said end user's computer.

25. The method of claim 23 wherein said end user's computer delivers said gathered information to said network server, said network server produces said set of identified targeted data content corresponding to said delivered gathered information, said network server forwards a request for said identified targeted data content to the third party server which contains said identified targeted data content, and said third party server then delivers said requested identified targeted data content to said end user's computer in response to said request.

26. The method of claim 23 wherein said end user's computer delivers said gathered information to said network server, said network server produces said set of identified targeted data content corresponding to said delivered gathered information, said network server forwards a request for said identified targeted data content to the third party server which contains said identified targeted data content, said third party server delivers said requested identified targeted data content to said network server in response to said request, and then said network server forwards said delivered targeted data content to said end user's computer.
